(19) United States
(12) Patent Application Publication
(10) Pub. No.: US 2003/0219607 A1
(43) Pub. Date: Nov. 27, 2003

(54) Reusable foil for hair coloring

(76) Inventor: Lora Ann Bozievich, Rancho Mirage, CA (US)

Correspondence Address: SHANKS & HERBERT, 1033 N. FAIRFAX STREET, SUITE 306, ALEXANDRIA, VA, 22314, US

(21) Appl. No.: 10/408,266

(22) Filed: Apr. 8, 2003

Related U.S. Application Data
(60) Provisional application No. 60/370,208, filed on Apr. 8, 2002.

(51) Int. Cl. B32B 15/08

(52) U.S. Cl. 428/457

(57) ABSTRACT

The present invention relates to laminated foils comprising a plastic member fused to one or both sides of a foil member for use in hair coloring.

This application claims priority to U.S. Provisional Application No. 60/370,208 filed Apr. 08, 2002.

### FIELD OF THE INVENTION

The present invention relates to reusable and recyclable laminated foils for use in hair coloring.

### BACKGROUND OF THE INVENTION

This invention relates to laminated foils for use in hair coloring. In the art, aluminum foil is commonly used for hair coloring. However, aluminum foil tears easily and is not re-usable. Lately pre-cut aluminum foil is being used for hair coloring as a way to promote efficient use of foils. However, these non reusable foils are not environmentally friendly and over time, can substantially add to the cost of hair coloring.

The present invention fulfils the need for recyclable and reusable foils both as a way to reduce cost of foils for the hair colorist and to provide them with environmentally friendly options.

### SUMMARY OF THE INVENTION

The present invention is directed to laminated foils usable for hair coloring. The foil may be the typical silver colored aluminum foil or colored foils. Lamination may be performed by use of transparent or colored plastic and may be one sided or both sided. The laminated foil may be precut and dispensable in a boxe or may be rolled for cutting as necessary. The laminated foils rinses, dries and sanitizes easily. Lamination may be accomplished by any means known in the art.

### BRIEF DESCRIPTION OF THE DRAWINGS

In the drawings, wherein like reference numerals identify similar elements throughout several views:

FIG. 1 shows a one-sided laminate foil.

FIG. 2 shows the laminated foil in use for hair coloring.

FIG. 3 shows the laminated foil in use for hair coloring.

FIG. 4 shows the laminated foil in use for hair coloring.

FIG. 5 shows the laminated foil in use for hair coloring.

FIG. 6 shows the laminated foil in use for hair coloring.

FIG. 7 shows the laminated foil in use for hair coloring.

### DETAILED DESCRIPTION OF THE PREFERRED EMBODIMENTS OF THE PRESENT INVENTION

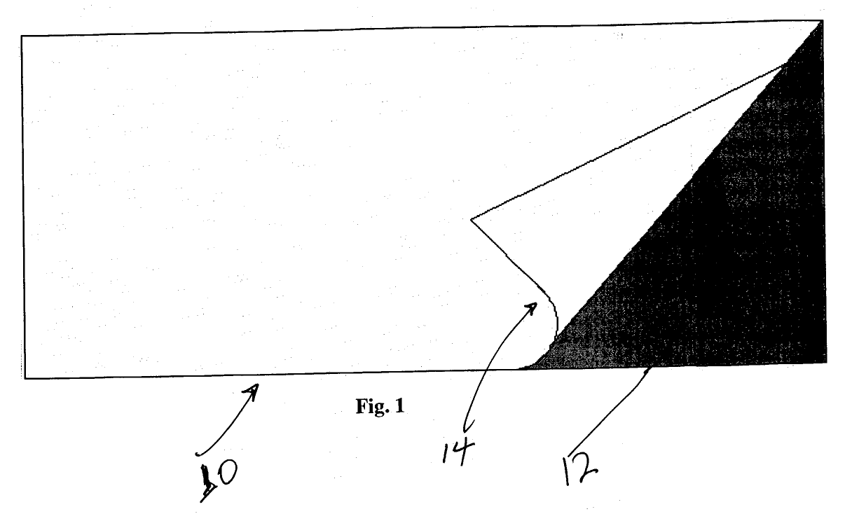

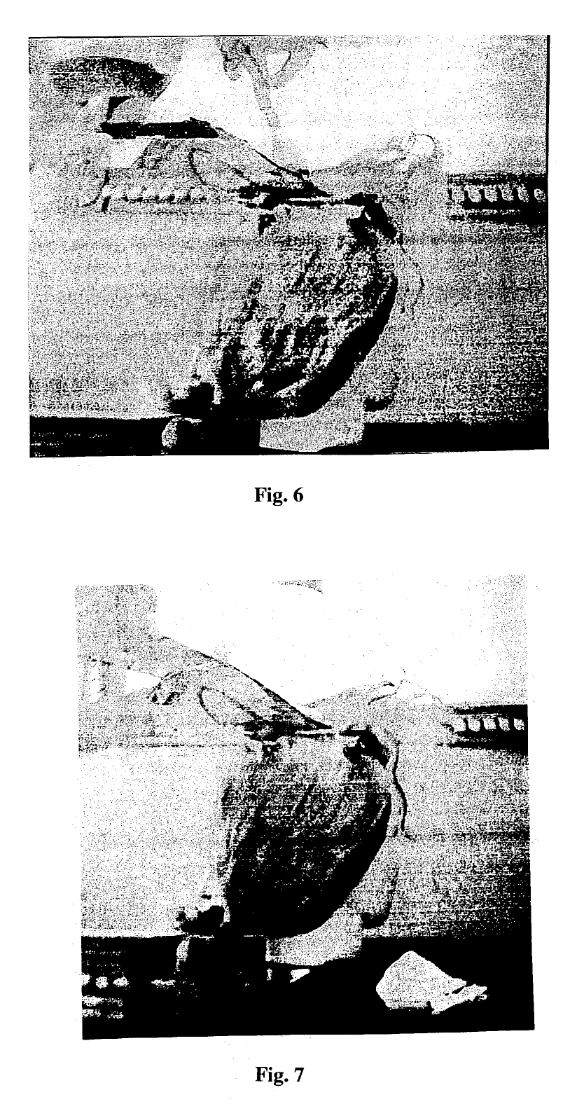

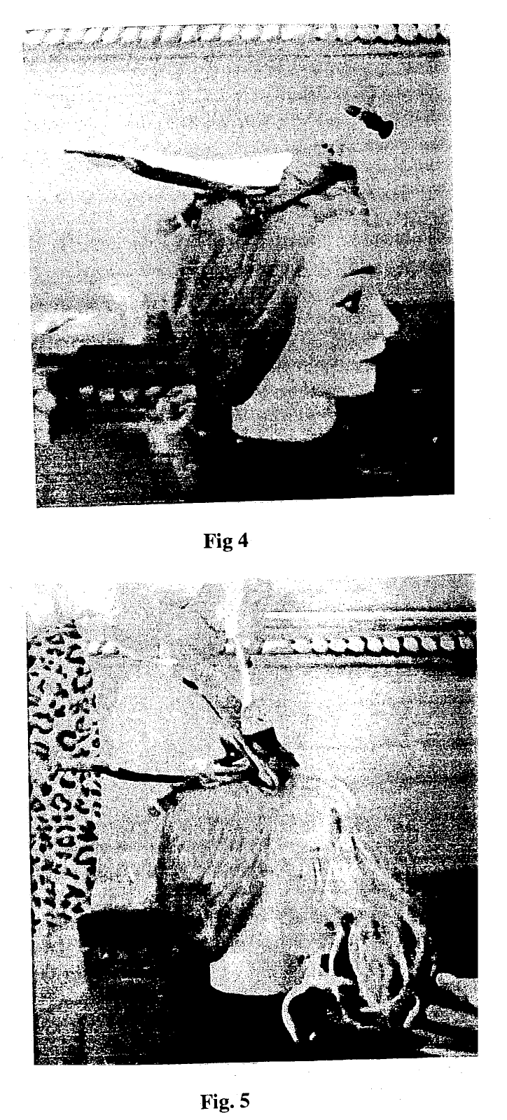

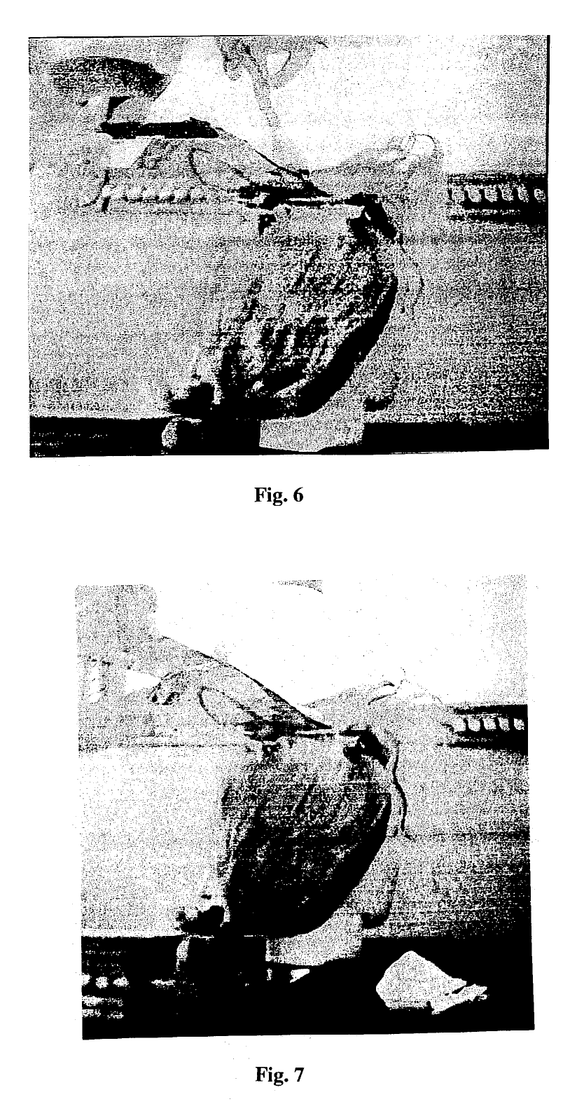

Referring now to the drawings of the present disclosure in which like numbers represent the same structure in the various views, FIG. 1 shows a pre-cut, one-sided laminated foil 10 comprising a foil member 12 and a plastic member 14. The foil member may be colored or silver colored. The plastic member also may be a clear plastic or a colored plastic. Lamination may be accomplished by any means known in the art and consists of heat aided fusing of the plastic member unto the foil member. Lamination is preferably accomplished by use of clear plastic member. The laminated foil may be rolled or preferably pre-cut in easily dispensable sizes. The thickness of the laminate varies but thin foil members coupled with thin plastic members such as packing tapes are preferred. Lamination may be one sided or dual sided. Lamination may be accomplished by fusing a plastic member to a foil member, followed by pre-cutting of the laminated foil.

In addition to resisting tear, the lamination feature allows the incorporation of a company's logo unto the laminated foil. This can be accomplished by laminating a logo matted with the foil member.

It is to be understood that the laminated foils of the present invention can be formed of any suitable plastic and metallic foil materials and the like and that the invention is not intended to be limited by the material from which the devices are formed.

It will also be apparent to those skilled in the art that various modifications and variations can be made to the laminated foils of the present invention without departing from the spirit or scope of the invention. Thus, it is intended that the present invention cover the modifications and variations of this invention provided they come within the scope of the appended claims and their equivalents. Accordingly, the invention is not limited by the embodiments described above which are presented as examples only but can be modified in various ways within the scope of protection defined by the appended patent claims.

I claim:

1. A laminated foil for use in hair coloring comprising:
a plastic member fused to a foil member.

2. The laminated foil of claim 1 wherein, the plastic member is fused to one side of the foil member.

3. The laminated foil of claim 1 wherein, the plastic member is fused to both sides of the foil member.

4. The laminated foil of claim 1 wherein the foil is dispensed in pre-cut forms.

5. The laminated foil of claim 1 wherein a company's logo or advertising material is placed between the plastic member and the foil member.
